(19) United States
(12) Patent Application Publication
(10) Pub. No.: US 2024/0216876 A1
(43) Pub. Date: Jul. 4, 2024

(54) MANUFACTURING APPARATUS AND MANUFACTURING METHOD FOR ULTRA FINE BUBBLE CONTAINING LIQUID

(71) Applicant: CANON KABUSHIKI KAISHA, Tokyo (JP)

(72) Inventor: AKIRA YAMAMOTO, Kanagawa (JP)

(21) Appl. No.: 18/543,211

(22) Filed: Dec. 18, 2023

(30) Foreign Application Priority Data
Dec. 28, 2022 (JP) 2022-211819

(51) Int. Cl. B01F 23/231; B01F 23/232

(52) U.S. Cl. CPC B01F 23/23105; B01F 23/2323

(57) ABSTRACT

A manufacturing apparatus for an ultra fine bubble containing liquid includes an ultra fine bubble generating unit to generate ultra fine bubbles in a liquid, a circulation path, a circulating unit, a blocking unit, and a control unit. The ultra fine bubble generating unit, the circulating unit, and the blocking unit are in the circulation path and the circulating unit circulates the liquid through the circulation path. The blocking unit switches between closing and opening of the circulation path. The control unit controls the ultra fine bubble generating unit, the circulating unit, and the blocking unit and alternately executes a first mode in which, with the blocking unit open, the ultra fine bubble generating unit is driven while the circulating unit is being driven, and a second mode in which, with the blocking unit closed and the ultra fine bubble generating unit stopped, the circulating unit is driven.

### BACKGROUND

### Field

The present disclosure relates to a manufacturing apparatus and a manufacturing method for an ultra fine bubble containing liquid.

### Description of the Related Art

In recent years, technologies have been developed that apply the properties of fine bubbles such as microbubbles with a diameter of 1 to 100 μm or ultra fine bubbles (hereinafter referred to as “UFB”) with a diameter of less than 1.0 μm. Japanese Patent Laid-Open No. 2019-42732 discloses a bubble generating method in which a film ebullition is generated on a liquid by a heater.

Japanese Patent laid-Open No. 2015-181976 discloses an apparatus that generates fine bubbles at high concentration using, a pressurized dissolution unit provided in a liquid circulation path and pressurizing and dissolving a desired gas into a liquid and a fine bubble generating unit provided in the same liquid circulation path and blowing out the liquid through fine nozzles to generate fine bubbles.

Some conventional UFB manufacturing apparatuses employ a method of generating UFBs with a diameter of less than 1.0 μm by using heating resistance elements to cause film boiling in the liquid and using a circulating mechanism to efficiently generate a UFB containing liquid with a high number density.

However, when such a conventional UFB manufacturing apparatus is operated for a long time, a UFB generating unit may generate heat to increase the temperature of the liquid, depositing dissolved gas in the liquid as air bubbles other than UFBs. Additionally, air bubbles may enter connections between pipes constituting a circulation path, and the like. When the liquid contains such air bubbles other than UFBs, the air bubbles inhibit bubbling, and thus the UFB generating unit may fail to stably generate UFBs.

### SUMMARY

The present disclosure provides a manufacturing apparatus and a manufacturing method for a UFB containing liquid which apparatus and method can suppress unstable generation of UFBs in a long-time operation.

According to an aspect of the present disclosure, a manufacturing apparatus for an ultra fine bubble containing liquid, the manufacturing apparatus includes an ultra fine bubble generating unit configured to generate ultra fine bubbles in a liquid, a circulation path for the liquid where the circulation path includes the ultra fine bubble generating unit, a circulating unit disposed in the circulation path on a downstream side of the ultra fine bubble generating unit and configured to circulate the liquid through the circulation path, a blocking unit disposed in the circulation path on an upstream side of the ultra fine bubble generating unit and configured to switch between closing and opening of the circulation path, and a control unit configured to control the ultra fine bubble generating unit, the circulating unit, and the blocking unit, wherein the control unit alternately executes a first mode in which, with the blocking unit open, the ultra fine bubble generating unit is driven while the circulating unit is being driven, and a second mode in which, with the blocking unit closed and the ultra fine bubble generating unit stopped, the circulating unit is driven.

According to the present disclosure, a manufacturing apparatus and a manufacturing method for a UFB containing liquid can be provided which apparatus and method can suppress unstable generation of UFBs in a long-time operation.

Further features of the present disclosure will become apparent from the following description of exemplary embodiments with reference to the attached drawings.

### BRIEF DESCRIPTION OF THE DRAWINGS

FIG. 1 is a schematic configuration diagram illustrating a manufacturing apparatus for an ultra fine bubble containing liquid;

FIG. 2 is a perspective view illustrating a UFB generating unit;

FIG. 3A is an exploded perspective view of a heating element substrate;

FIG. 3B is an exploded perspective view of a heating element substrate;

FIG. 4 is a block diagram illustrating a control configuration in the manufacturing apparatus for a UFB containing liquid;

FIG. 5 is a flowchart illustrating processing for generating a UFB containing liquid;

FIG. 6 is a flowchart illustrating the processing of a UFB generating process;

FIG. 7A is a flowchart illustrating the processing of a UFB generating process;

FIG. 7B is a flowchart illustrating the processing of a UFB generating process; and

FIG. 7C is a flowchart illustrating the processing of a UFB generating process.

### DESCRIPTION OF THE EMBODIMENTS

### First Embodiment

A first embodiment of the present disclosure will be described below with reference to the drawings.

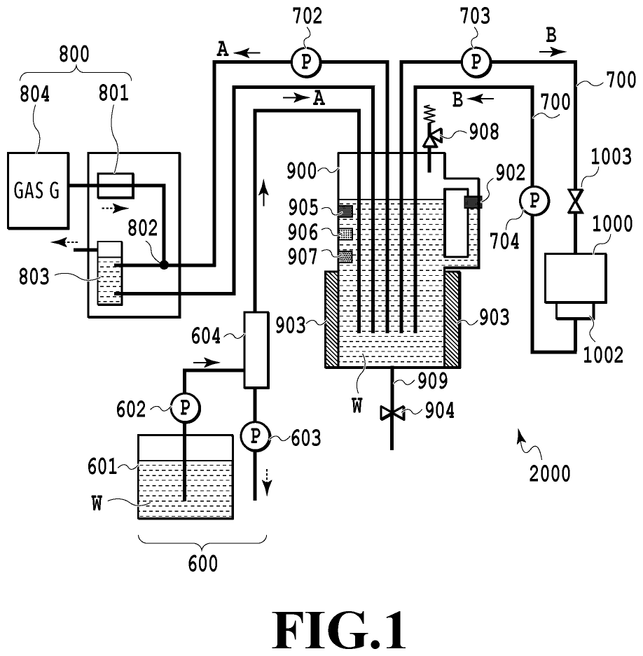

FIG. 1 is a schematic configuration diagram illustrating an ultra fine bubble containing liquid manufacturing apparatus 2000 (hereinafter referred to as a “UFB containing liquid manufacturing apparatus 2000”) to which the present embodiment is applicable. The UFB containing liquid manufacturing apparatus 2000 includes a liquid feeding unit 600, a gas dissolving unit 800, an accommodation chamber 900, and an ultra fine bubble generating unit 1000 (hereinafter referred to as a “UFB generating unit 1000”). In FIG. 1, solid arrows indicate flows of liquid, and dashed arrows indicate flows of gas.

The liquid feeding unit 600 includes a liquid reservoir unit 601, two pumps 602 and 603, and a deaeration unit 604. A liquid W reserved in the liquid reservoir unit 601 is delivered by the pump 602 via the deaeration unit 604 to the accommodation chamber 900, which can accommodate the liquid. Inside the deaeration unit 604, a membrane is deployed that can be passed through only by gas. The pump 603 decompresses the inside of the deaeration unit 604 to allow only gas to pass through the membrane, separating the gas from the liquid. The liquid W flows toward the accommodation chamber 900, and the gas is discharged to the outside. Various gases may be dissolved in the liquid reserved in the liquid reservoir unit 601. However, by using the deaeration unit 604 to remove the gases dissolved in the liquid before delivery of the liquid to the accommodation chamber 900, dissolution efficiency in a gas dissolving step, which is a post-process, can be increased.

The gas dissolving unit 800 includes a gas feeding unit 804, a pre-process unit 801, a joining unit 802, and a gas-liquid separating chamber 803. The gas feeding unit 804 may be a cylinder in which a desired gas G is stored but may be an apparatus that can continuously generate the desired gas G. For example, in a case that the desired gas G is oxygen, the gas feeding unit 804 may be an apparatus that takes in air, removes nitrogen from the air, and continuously feeds, to the pump, the gas from which nitrogen has been removed.

The gas G fed from the gas feeding unit 804 is subjected to processing such as discharge by the pre-process unit 801, and the processed gas joins, at the joining unit 802, the liquid W flowing out from the accommodation chamber 900. At this time, a portion of the gas G is dissolved into the liquid W. The gas G and liquid W joined together are separated from each other again by the gas-liquid separating chamber 803, and a portion of the gas G that has not been dissolved into the liquid W is discharged to the outside. The liquid W in which the gas G has been dissolved is fed to the ultra fine bubble generating unit 1000 by the pump 704.

The accommodation chamber 900 accommodates a mixture of the liquid W fed from the liquid feeding unit 600, the liquid W in which the desired gas G has been dissolved by the gas dissolving unit 800, and the UFB containing liquid generated by the UFB generating unit 1000. A temperature sensor 905 detects the temperature of the liquid accommodated in the accommodation chamber 900. A liquid level sensor 902 is disposed at a predetermined height in the accommodation chamber 900 to detect the level of the liquid W. A UFB concentration sensor (concentration detecting unit) 906 detects the UFB concentration of the liquid accommodated in the accommodation chamber 900. A solubility sensor 907 detects the solubility of the gas in the liquid W accommodated in the accommodation chamber 900. A valve 904 is opened when the liquid W accommodated in the accommodation chamber 900 is discharged to an external container via a collection path 909. Note that although not illustrated, the accommodation chamber 900 may internally be provided with a stirring unit for uniformizing the temperature of the liquid W and the distribution of the UFB.

A cooling unit 903 can control the temperature of the liquid W accommodated in the accommodation chamber 900 to cool the liquid W with the temperature thereof increased. To allow the gas dissolving unit 800 to efficiently dissolve the desired gas, the gas temperature of the liquid W to be fed to the gas dissolving unit 800 is preferably as low as possible. In the present embodiment, with the temperature sensor 905 detecting the temperature of the liquid W, the cooling unit 903 is used to adjust the temperature of the liquid W to be fed to the gas dissolving unit 800 to 10° C. or lower. The configuration of the cooling unit 903 can employ, for example, though not limited to, a method using a Peltier element, a method of circulating liquid cooled with a chiller, or the like. In the latter case, a cooling pipe through which a cooling liquid is circulated may be wound around an outer circumference of the accommodation chamber 900, or the accommodation chamber 900 may have a hollow structure in which a cooling pipe may be disposed. Additionally, the cooling pipe may be immersed in the liquid W in the accommodation chamber 900.

On an upstream side of the ultra fine bubble generating unit 1000, a valve 1003 (blocking unit) is provided that can block a channel, and on a downstream side of the ultra fine bubble generating unit 1000, a pump 704 is provided.

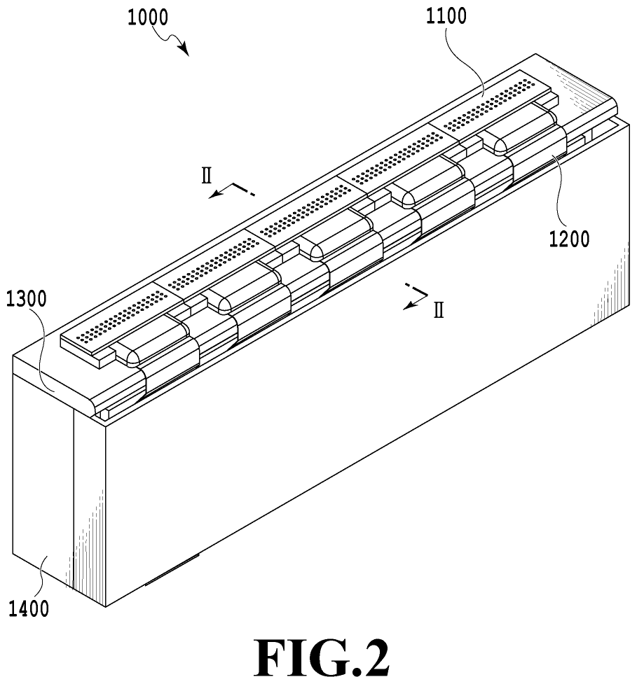

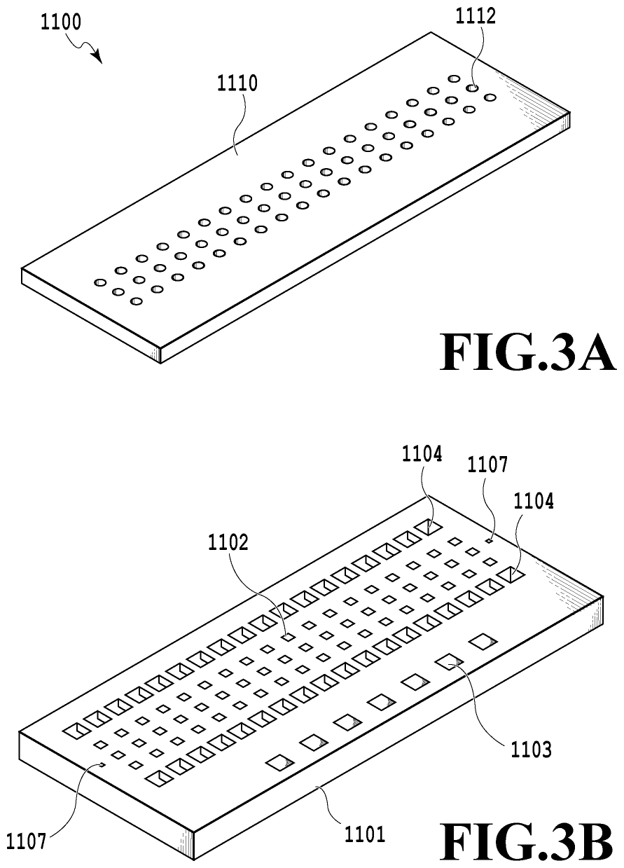

FIG. 2 is a perspective view illustrating the ultra fine bubble generating unit 1000, and FIG. 3A, 3B is an exploded perspective view of a heating element substrate 1100. The ultra fine bubble generating unit 1000 described above generates UFBs in the liquid having flowed into the ultra fine bubble generating unit 1000. As a method for generating UFBs, a thermal-ultra fine bubble (hereinafter also referred to as “T-UFB”) method is used in which film boiling is caused at an interface between a heating element 1102 and the liquid. The ultra fine bubble generating unit 1000 includes a plurality of heating element substrates 1100. The heating element substrate 1100 includes an Si substrate 1101 and an ejection port plate 1110, and a plurality of ejection ports 1112 is disposed in the ejection port plate 1110. A plurality of heating elements 1102 is disposed on the Si substrate 1101. A plurality of the heating element substrates 1100 is arranged by being supported by a support member 1300 attached to a UFB unit housing 1400. Terminals 1103 are disposed on the Si substrate 1101 for connection to flexible wires 1200. The heating elements 1102 are supplied with power via the flexible wires 1200 and the terminals 1103. Application of voltage pulses cause the heating elements 1102 to generate heat. The liquid is fed from feeding paths 1104 to the heating elements 1102, which then generate heat to eject, from the ejection ports 1112, liquid droplets containing UFBs. Additionally, temperature sensors (temperature detecting unit) 1107 are formed in areas of the heating element substrate 1100 in which no heating elements 1102 are formed. The temperature sensors 1107 read the temperature of the heating element substrate 1100.

As illustrated in FIG. 1, piping 700 connects together the liquid feeding unit 600, the gas dissolving unit 800, the accommodation chamber 900, and the ultra fine bubble generating unit 1000. Thus, a path is formed through which the liquid W is circulated by a pump 702, a feeding pump 703, and a collection pump 704. FIG. 1 illustrates a case in which a circulation path A for dissolving gas and a circulation path B for generating a UFB containing liquid are formed. In this case, circulation is enabled in the circulation paths A and B under any respective conditions.

The liquid W can be circulated through the circulation path B regardless of whether the UFB generating unit 1000 is driven. While the UFB generating unit 1000 is not driven, the liquid is circulated from the feeding paths 1104 via front surfaces of the heating elements 1102 through the ejection ports 1112. While the UFB generating unit 1000 is being driven, the liquid is circulated that is fed from the feeding paths 1104 and ejected from the ejection ports 1112 by driving of the heating elements 1102. The flow velocity in the circulation path B needs only to be determined in accordance with the total amount of liquid droplets ejected from the ejection ports 1112 of the UFB generating unit 1000, and the like.

Note that FIG. 1 illustrates a configuration provided with the circulation path A provided with the gas dissolving unit 800 in the middle of the circulation path to dissolve the gas G but that the gas G may be fed directly to the accommodation chamber 900. This allows realization of a further miniaturized manufacturing apparatus for UFB containing liquid.

Additionally, the positions and number of pumps are not limited to those indicated in FIG. 1. Furthermore, the configuration of each unit may be provided with a pump and a valve required to drive the unit. However, the pump used preferably has reduced pulsation and variation in flow rate in order to prevent a reduction in generation efficiency for UFBs. Furthermore, instead of being provided in the collection chamber 900, the collection path 909 and the valve 904 for collecting the liquid W may be provided at other positions in the liquid circulation path. Additionally, the temperature sensor 905, the UFB concentration sensor 906, and the solubility sensor 907 need not necessarily be provided at the positions illustrated in FIG. 1. These sensors may be provided at other positions as long as the positions are within the circulation path. Furthermore, the sensors may be provided at a plurality of positions within the circulation path and configured to output average values.

Materials having high corrosion resistance are preferably used to form members contacting the UFB containing liquid, such as the piping, the feeding pump 703, the collection pump 704, the valve 1003, the accommodation chamber 900, the UFB generating unit 1000. For example, a fluorine-containing resin such as polytetrafluoroethylene (PTFE) or perfluoroalkoxy alkane, a metal such as SUS316L, or any other material can be suitably used. This allows UFBs to be suitably generated even in a case that a corrosive gas G or liquid W is used.

Note that the present embodiment provides a configuration in which circulation takes place between the UFB generating unit 1000 and the accommodation chamber 900 via the circulation path B but that the UFB generating unit 1000 internally includes a process of ejecting liquid droplets from the ejection ports and collecting the liquid droplets in a collection member 1002. Accordingly, the circulation path includes a portion in which the liquid flies through gaps in the form of liquid droplets.

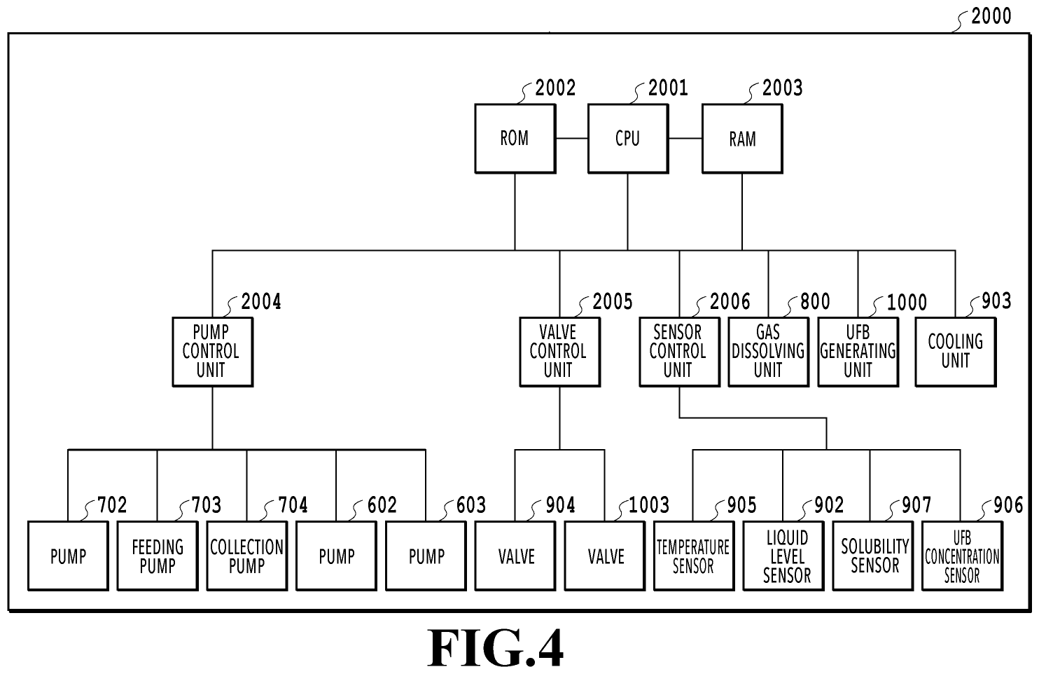

FIG. 4 is a block diagram illustrating a control configuration in the UFB containing liquid manufacturing apparatus 2000. A CPU 2001 controls the entire apparatus in accordance with programs saved in a ROM 2002 using a RAM 2003 as a work area. Under the control of the CPU 2001, a pump control unit 2004 controls driving of various pumps included in the circulation path illustrated in FIG. 1, the various pumps including the pumps 602, 603, 702, 703, and 704. A valve control unit 2005 is configured in such a manner that, under the control of the CPU 2001, the valve control unit 2005 can control opening and closing of various valves including the valves 904 and 1003. Under the control of the CPU 2001, a sensor control unit 2005 controls various sensors including the solubility sensor 907, the liquid level sensor 902, the temperature sensor 905, and the UFB concentration sensor 906 and provides the CPU 2001 with detected values from the various sensors.

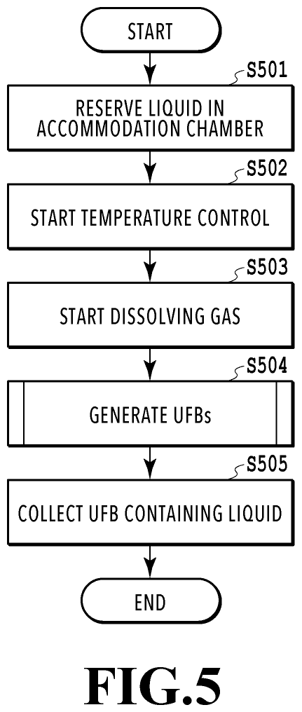

FIG. 5 is a flowchart illustrating processing for generating a UFB containing liquid in the UFB containing liquid manufacturing apparatus 2000 according to the present embodiment. The processing for generating a UFB containing liquid according to the present embodiment will be described with reference to the flowchart in FIG. 5. The series of processing operations illustrated in FIG. 5 is executed by the CPU 2001 of the UFB containing liquid manufacturing apparatus 2000 decompressing and running, in the RAM 2003, program code stored in the ROM 2002. Alternatively, some or all of the steps in FIG. 5 may be implemented by hardware such as an ASIC or an electronic circuit. Note that the symbol “S” in the description of each processing operation means a step in the flowchart.

When the processing for generating a UFB containing liquid is started, the CPU 2001 reserves a predetermined amount of liquid in the accommodation chamber 900. Specifically, the CPU 2001 drives the pumps 602 and 603 while monitoring detection by the liquid level sensor 602. Thus, the liquid W reserved in the liquid feeding component 600 is delivered to the accommodation chamber 900 while being deaerated by the deaeration unit 604. Then, when the liquid level sensor 902 detects the liquid level, the CPU 2001 stops driving the pumps 602 and 603. Thus, a predetermined amount of liquid W is reserved in the accommodation chamber 900. Subsequently, in S502, the CPU 2001 starts temperature control for the liquid W accommodated in the accommodation chamber 900. Specifically, the CPU 2001 causes the cooling unit 903 to be driven while monitoring the detected temperature from the temperature sensor 905. Then, in S503, when the detected temperature from the temperature sensor 905 is 10° C. or lower, the CPU 2001 starts gas dissolution. Specifically, the CPU 2001 causes the gas dissolving unit 800 to be driven and drives the pump 702 to start circulating the liquid W through the circulation path A.

Subsequently, in S504, when the solubility sensor 907 detects a predetermined solubility, the CPU 2001 performs UFB generation. The UFB generation will be described below in detail. Note that the temperature control and the gas solubility control are continuously performed during the UFB generation. That is, with the temperature sensor 905 and the solubility sensor 907 monitored, driving of each unit is started and stopped. Then, in S505, the CPU 2001 causes all of the driving to be ended, opens the valve 904 to collect the UFB containing liquid, and ends the processing.

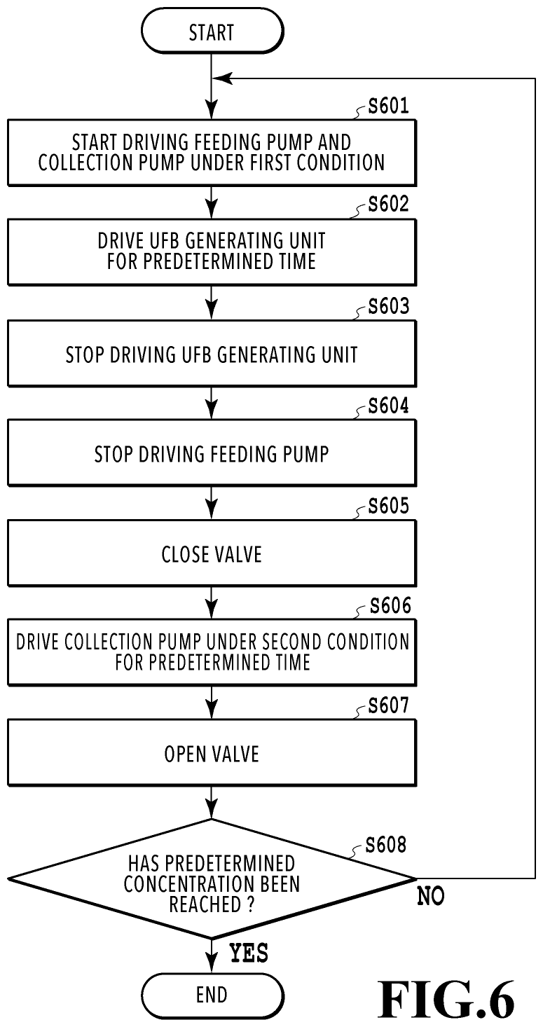

FIG. 6 is a flowchart illustrating the processing of the UFB generating step (S504) in the processing for generating a UFB containing liquid illustrated in FIG. 5. With reference to the flowchart in FIG. 6, a case of long-time continuous generation in the UFB generating step will be described below in detail.

When the UFB generating step is started, in S601, the CPU 2001 drives the feeding pump 703 and the collection pump 704 under a first condition to cause circulation. Subsequently, in S602, the CPU 2001 drives the UFB generating unit 1000 for a predetermined time. Then, in S603, the CPU 2001 stops driving the UFB generating unit 1000, and in S604, stops driving the feeding pump 703. Then, in S605, the CPU 2001 closes the valve 1003. Then, in S606, with the valve 1003 closed, the CPU 2001 switches the collection pump 704 to a second condition to cause the collection pump 704 to be driven for a predetermined time, thus sucking the liquid W inside the UFB generating unit 1000. Thus, bubbles generated and entrapped inside the UFB generating unit 1000 are also removed. Subsequently, in S607, the CPU 2001 opens the valve 1003. Opening the valve 1003 fills the inside of the UFB generating unit 1000 with the liquid W. Subsequently, in S608, the CPU 2001 determines, based on a detected value from the UFB concentration sensor 906, whether the concentration of UFBs in the UFB containing liquid in the accommodation chamber 900 has reached a predetermined value. In a case that the concentration has not reached the predetermined concentration, the CPU 2001 returns to S901 to repeat the processing. In a case that the concentration has reached the predetermined concentration, the CPU 2001 ends the processing. In the present embodiment, the first condition (first mode) is 30 mL/min, and the second condition is 300 mL/min.

Even in a case that the second condition is the same as the first condition, air bubbles can be removed, but to suck the liquid W inside the UFB generating unit 1000 in a shorter time, the second condition desirably includes a higher flow velocity than the first condition.

The above-described sequence causes air bubbles inside the UFB generating unit 1000 to be collected in the accommodation chamber 900. The collected air bubbles are redissolved in the accommodation chamber 900 or float to a position above the liquid level and are exhausted from an exhaust valve 908 when a certain pressure is exceeded.

By removing the air bubbles in the UFB generating unit 1000 as described above reduces a variation in gas solubility in the liquid caused by an increased temperature to enable stable long-time driving. This allows stable manufacturing of a UFB containing liquid with a concentration of several hundred million to several billion bubbles/mL.

Note that the embodiment has been described using, as an example, the UFB containing liquid manufacturing apparatus using the T-UFB method but that the embodiment is not limited to this generation method and is applicable using any other method. Additionally, the embodiment can be applied not only to a manufacturing apparatus for UFBs with a diameter of less than 1 μm but also to a manufacturing apparatus for microbubbles with a diameter of 1 to 100 μm.

### Second Embodiment

A second embodiment of the present disclosure will be described below with reference to the drawings. Note that the basic configuration of the present embodiment is similar to the basic configuration of the first embodiment and thus that characteristic components will be described below. In the present embodiment, processing for cooling the UFB generating unit 1000 is executed by the processing of the UFB generating process.

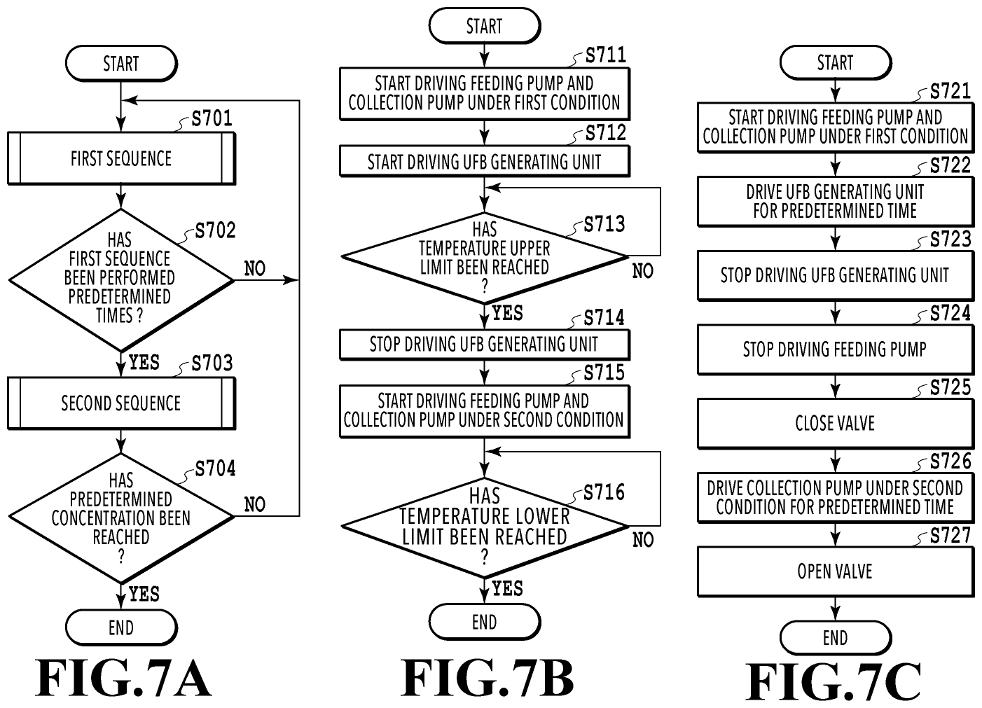

FIG. 7A is a flowchart illustrating the processing of the UFB generating process according to the present embodiment. FIG. 7B is a flowchart illustrating processing in S701 in FIG. 7A. FIG. 7B is a flowchart illustrating processing in S701 in FIG. 7A. With reference to the flowcharts in FIGS. 7A to 7C, the UFB generating process according to the present embodiment will be described.

First, the flowchart in FIG. 7A will be described. When the UFB generating process is started, the CPU 2001 performs a first sequence in S701. The first sequence will be described below in detail. Subsequently, in S702, the CPU 2001 determines whether the first sequence has been performed a predetermined number of times. In a case that the first sequence has not been performed the predetermined number of times, the CPU 2001 returns to S701 to perform the first sequence again. In a case that the first sequence has been performed the predetermined number of times, the CPU 2001 transitions to S703 to perform a second sequence. The second sequence will be described below in detail. Subsequently, in S704, the CPU 2001 determines, based on the detected value from the UFB concentration sensor 906, whether the concentration of UFBs in the UFB containing liquid in the accommodation chamber 900 has reached a predetermined value. In a case that the concentration has not reached the predetermined value, the CPU 2001 returns to S701 to repeat the processing. In this manner, the first sequence and the second sequence are alternatively performed. In a case that the predetermined concentration has been reached, the processing is ended.

The first sequence in S701 in FIG. 7A corresponds to the flowchart in FIG. 7B. When the first sequence is started, in S711, the CPU 2001 drives the collection pump 704 under the first condition to cause circulation through the circulation path B. Subsequently, in S712, the CPU 2001 drives the UFB generating unit 1000. Then, in S713, the CPU 2001 determines whether the value from the temperature sensor 110 on the heating element substrate 1100 has reached a preset upper limit value. In a case that the value has not reached the upper limit value, CPU 2001 repeats the determination until the value reaches the upper limit value. In a case that the value has reached the upper limit value, CPU 2001 transitions to S714 to stop driving the UFB generating unit 1000.

Subsequently, in S715, the CPU 2001 switches the collection pump 704 from the operation under the first condition to the operation under the second condition and performs driving. This cools the UFB generating unit 1000. Then, in 716, the CPU 2001 determines whether the detected temperature from the temperature sensor 1107 has reached a preset lower limit value. In a case that the detected temperature has not reached the lower limit value, the CPU 2001 repeats the determination until the detected temperature reaches the lower limit value. When the value from the temperature sensor 1107 reaches the lower limit value, the CPU 2001 ends the processing.

In a case that the temperature sensor 1107 outputs a value exceeding the temperature upper limit or the temperature lower limit, the driving may be immediately switched. However, with the effects of noise taken into account, switching may be performed after confirmation of output of a value exceeding the upper or lower limit value for a certain time (for example, approximately 0.5 seconds).

A second sequence in S703 in FIG. 7A corresponds to the flowchart illustrated in FIG. 7C. The flowchart in FIG. 7C is similar to the processing from S601 to S607 in the flowchart described in FIG. 6. Consequently, the description of the second sequence and the flowchart in FIG. 7C is omitted.

As described above, not only by removing the air bubbles in the UFB generating unit 1000 but also by adjusting the temperature of the UFB generating unit 1000 to within a predetermined range, a variation in gas solubility in the liquid caused by an increased temperature is reduced, allowing a UFB containing liquid to be more stably manufactured.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described Embodiments and/or that includes one or more circuits (e.g., application specific integrated circuit (ASIC)) for performing the functions of one or more of the above-described Embodiments, and by a method performed by the computer of the system or apparatus by, for example, reading out and executing the computer executable instructions from the storage medium to perform the functions of one or more of the above-described Embodiments and/or controlling the one or more circuits to perform the functions of one or more of the above-described Embodiments. The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-211819 filed Dec. 28, 2022, which is hereby incorporated by reference wherein in its entirety.

What is claimed is:

1. A manufacturing apparatus for an ultra fine bubble containing liquid, the manufacturing apparatus comprising:
an ultra fine bubble generating unit configured to generate ultra fine bubbles in a liquid;
a circulation path for the liquid where the circulation path includes the ultra fine bubble generating unit;
a circulating unit disposed in the circulation path on a downstream side of the ultra fine bubble generating unit and configured to circulate the liquid through the circulation path;
a blocking unit disposed in the circulation path on an upstream side of the ultra fine bubble generating unit and configured to switch between closing and opening of the circulation path; and
a control unit configured to control the ultra fine bubble generating unit, the circulating unit, and the blocking unit,
wherein the control unit alternately executes a first mode in which, with the blocking unit open, the ultra fine bubble generating unit is driven while the circulating unit is being driven, and a second mode in which, with the blocking unit closed and the ultra fine bubble generating unit stopped, the circulating unit is driven.

2. The manufacturing apparatus according to claim 1, wherein the control unit executes a third mode in which, with the blocking unit open and the ultra fine bubble generating unit stopped, the circulating unit is driven to achieve a flow velocity higher than that in the first mode.

3. The manufacturing apparatus according to claim 2, further comprising a temperature detecting unit for detecting a temperature of the ultra fine bubble generating unit,
wherein the control unit switches from the first mode to the third mode based on the temperature detected by the temperature detecting unit.

4. The manufacturing apparatus according to claim 3, wherein the control unit switches from the first mode to the third mode in a case that the detected temperature from the temperature detecting unit reaches a predetermined temperature upper limit.

5. The manufacturing apparatus according to claim 3, wherein the ultra fine bubble generating unit includes a plurality of the temperature detecting unit, and in a case that an average value of the detected temperature from the temperature detecting unit reaches a predetermined temperature upper limit, the first mode is switched to the third mode.

6. The manufacturing apparatus according to claim 3, wherein the ultra fine bubble generating unit includes a plurality of the temperature detecting unit, and in a case that a highest value of the detected temperature from the temperature detecting unit reaches a predetermined temperature upper limit, the first mode is switched to the third mode.

7. The manufacturing apparatus according to claim 3, wherein the control unit ends the third mode in a case that the detected temperature from the temperature detecting unit reaches a predetermined temperature lower limit.

8. The manufacturing apparatus according to claim 3, wherein the ultra fine bubble generating unit includes a plurality of the temperature detecting unit, and in a case that an average value of the detected temperature from the temperature detecting unit reaches a predetermined temperature lower limit, the third mode is ended.

9. The manufacturing apparatus according to claim 3, wherein the ultra fine bubble generating unit includes a plurality of the temperature detecting unit, and in a case that a lowest value of the detected temperature from the temperature detecting unit reaches a predetermined temperature lower limit, the third mode is ended.

10. The manufacturing apparatus according to claim 1, further comprising an accommodating unit disposed in a middle of the circulation path and configured to accommodate the liquid.

11. The manufacturing apparatus according to claim 10, further comprising a temperature control unit for controlling a temperature of the liquid accommodated in the accommodating unit.

12. The manufacturing apparatus according to claim 10, further comprising a stirring unit for stirring the liquid accommodated in the accommodating unit.

13. The manufacturing apparatus according to claim 10, further comprising a concentration detecting unit for detecting a concentration of ultra fine bubbles in the liquid accommodated in the accommodating unit.

14. The manufacturing apparatus according to claim 1, wherein the ultra fine bubble generating unit generates ultra fine bubbles by causing a heating element to generate heat to cause film boiling at an interface between the liquid and the heating element.

15. A method for a manufacturing apparatus to manufacture an ultra fine bubble containing liquid, wherein the manufacturing apparatus includes an ultra fine bubble generating unit, a circulation path that includes the ultra fine bubble generating unit, a circulating unit disposed on a downstream side of the ultra fine bubble generating unit, and a blocking unit disposed in the circulation path on an upstream side of the ultra fine bubble generating unit, the method comprising:
generating ultra fine bubbles in a liquid using the ultra fine bubble generating unit;
circulating the liquid through the circulation path using the circulating unit;
switching between closing and opening of the circulation path using the blocking unit; and
alternately executing a first mode in which, with the blocking unit open, the ultra fine bubble generating unit is driven while the circulating unit is being driven, and a second mode in which, with the blocking unit closed and the ultra fine bubble generating unit stopped, the circulating unit is driven.
